(19) United States
(12) Patent Application Publication
(10) Pub. No.: US 2013/0316473 A1
(43) Pub. Date: Nov. 28, 2013

(54) METHOD OF PROCESSING INKJET HEAD SUBSTRATE

(71) Applicant: CANON KABUSHIKI KAISHA, Tokyo (JP)

(72) Inventors: Taichi Yonemoto, Isehara-shi (JP); Kenta Furusawa, Yokohama-shi (JP); Keisuke Kishimoto, Yokohama-shi (JP)

(73) Assignee: CANON KABUSHIKI KAISHA, Tokyo (JP)

(21) Appl. No.: 13/901,488

(22) Filed: May 23, 2013

(30) Foreign Application Priority Data
May 25, 2012 (JP) 2012-119401

(51) Int. Cl. B41J 2/16

(52) U.S. Cl. CPC B41J 2/1628
USPC 438/21

(57) ABSTRACT

A method of processing an inkjet head substrate includes, in series, a step of forming a barrier layer on a substrate and forming a seed layer on the barrier layer, a step of forming a resist film on the seed layer and patterning the resist film such that the resist film has an opening corresponding to a wiring section configured to drive ink discharge energy-generating elements, a step of forming the wiring section in the opening of the patterned resist film, a step of removing the resist film, a step of laser-processing a surface of the substrate, a step of forming an ink supply port by anisotropically etching the substrate, and a step of removing the barrier layer and the seed layer.

### BACKGROUND OF THE INVENTION

1. Field of the Invention

The present invention relates to a method of processing an inkjet head substrate.

2. Description of the Related Art

There is a method of forming a through-hole for supplying ink in a silicon substrate having semiconductor elements and the like using a laser. Debris caused by laser processing adheres to the semiconductor elements to affect discharge performance and/or a mounting step in some cases. Japanese Patent Laid-Open No. 5-330046 discloses a method in which a protective film made of resin is provided on a surface of a silicon substrate that has semiconductor elements and the like in advance, debris caused by laser processing is trapped with the protective film, and the protective film is removed, whereby the debris is prevented from adhering to the semiconductor elements.

### SUMMARY OF THE INVENTION

The present invention provides a method of processing an inkjet head substrate. The method includes the following steps in this order:

(a) a step of forming a barrier layer on a substrate and forming a seed layer on the barrier layer,
(b) a step of forming a resist film on the seed layer and patterning the resist film such that the resist film has an opening corresponding to a wiring section configured to drive ink discharge energy-generating elements,
(c) a step of forming the wiring section in the opening of the patterned resist film,
(d) a step of removing the resist film,
(e) a step of laser-processing a surface of the substrate
(f) a step of forming an ink supply port by anisotropically etching the substrate, and
(g) a step of removing the barrier layer and the seed layer.

Furthermore, the present invention provides a method of processing an inkjet head substrate. This method includes the following steps in this order:

(a) a step of forming a barrier layer on a substrate and forming a seed layer on the barrier layer,
(b) a step of laser-processing a surface of the substrate,
(c) a step of forming a resist film on the seed layer and patterning the resist film such that the resist film has an opening corresponding to a wiring section configured to drive ink discharge energy-generating elements,
(d) a step of forming the wiring section in the opening of the patterned resist film,
(e) a step of removing the resist film,
(f) a step of forming an ink supply port by anisotropically etching the substrate, and
(g) a step of removing the barrier layer and the seed layer.

Further features of the present invention will become apparent from the following description of exemplary embodiments with reference to the attached drawings.

### BRIEF DESCRIPTION OF THE DRAWINGS

FIGS. 1A to 1E are sectional views illustrating a method of processing an inkjet head substrate according to a first embodiment of the present invention.

FIGS. 2A to 2H are sectional views and top views illustrating the method according to the first embodiment.

FIGS. 3A to 3E are sectional views illustrating a method of processing an inkjet head substrate according to a second embodiment of the present invention.

FIGS. 4A to 4H are sectional views and top views illustrating the method according to the second embodiment.

FIG. 5 is a perspective view of an example of an inkjet head manufactured by a method according to the present invention.

### DESCRIPTION OF THE EMBODIMENTS

The method disclosed in Japanese Patent Laid-Open No. 5-330046 needs a step of applying resin for forming the protective film prior to laser processing and a step of removing the protective film subsequently to laser processing. In the method, the number of steps necessary for laser processing is large and it is difficult to simplify the steps necessary for laser processing. The present invention has been made in view of the above circumstances and is intended to provide a method of processing an inkjet head substrate, the method being capable of omitting a step of forming a protective film for protecting a surface of a substrate from debris caused by laser processing and a step of removing the protective film.

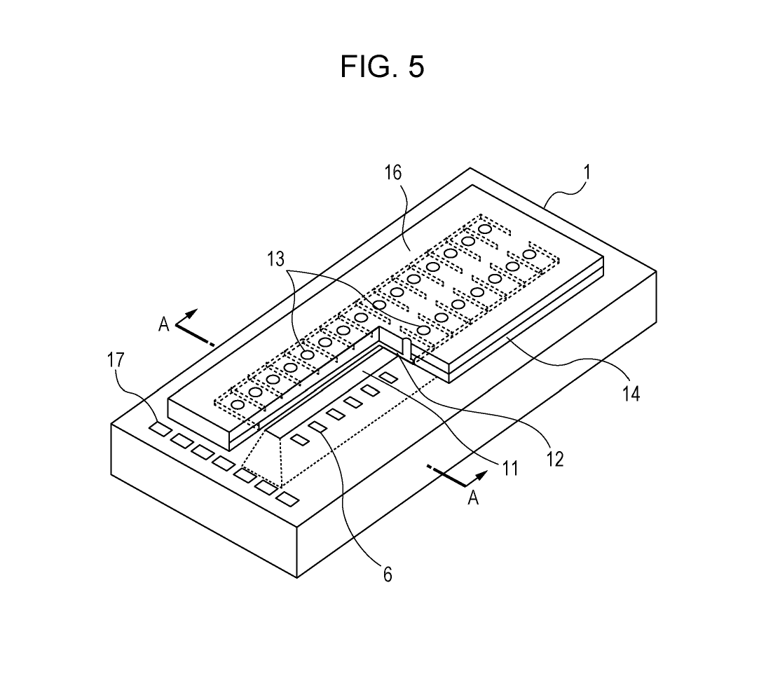

FIG. 5 shows an example of an inkjet head manufactured by a method according to the present invention. As shown in FIG. 5, the inkjet head includes a substrate 1 made of silicon and ink discharge energy-generating elements 6 arranged in two rows on the substrate 1 at a predetermined pitch. The substrate 1 is overlaid with a passage-forming member 14 and an ink discharge port-forming member 16. The passage-forming member 14 has a passage 12. The ink discharge port-forming member 16 is made of resin and has ink discharge ports 13 open above the ink discharge energy-generating elements 6. Furthermore, the substrate 1 is overlaid with a wiring section, which is not shown, for driving the ink discharge energy-generating elements 6. The wiring section is placed in the passage-forming member 14 and is connected to the ink discharge energy-generating elements 6. An ink supply port 11 extends between two rows of the ink discharge energy-generating elements 6. The ink supply port 11 communicates with the ink discharge ports 13 through the passage 12. The inkjet head performs recording in such a manner that the pressure generated by the ink discharge energy-generating elements 6 is applied to ink filled in the passage 12 through the ink supply port 11 and droplets of the ink are thereby discharged from the ink discharge ports 13 and are applied to a recording medium. Furthermore, the substrate 1 is overlaid with pad sections 17, exposed outside, for electrically connecting the inkjet head to a body.

### First Embodiment

A method of processing an inkjet head substrate according to a first embodiment of the present invention includes the following steps in this order:

(a) a step of forming a barrier layer on a substrate and forming a seed layer on the barrier layer,
(b) a step of forming a resist film on the seed layer and patterning the resist film such that the resist film has an opening corresponding to a wiring section configured to drive ink discharge energy-generating elements,
(c) a step of forming the wiring section in the opening of the patterned resist film,
(d) a step of removing the resist film,
(e) a step of laser-processing a surface of the substrate,
(f) a step of forming an ink supply port by anisotropically etching the substrate, and
(g) a step of removing the barrier layer and the seed layer.

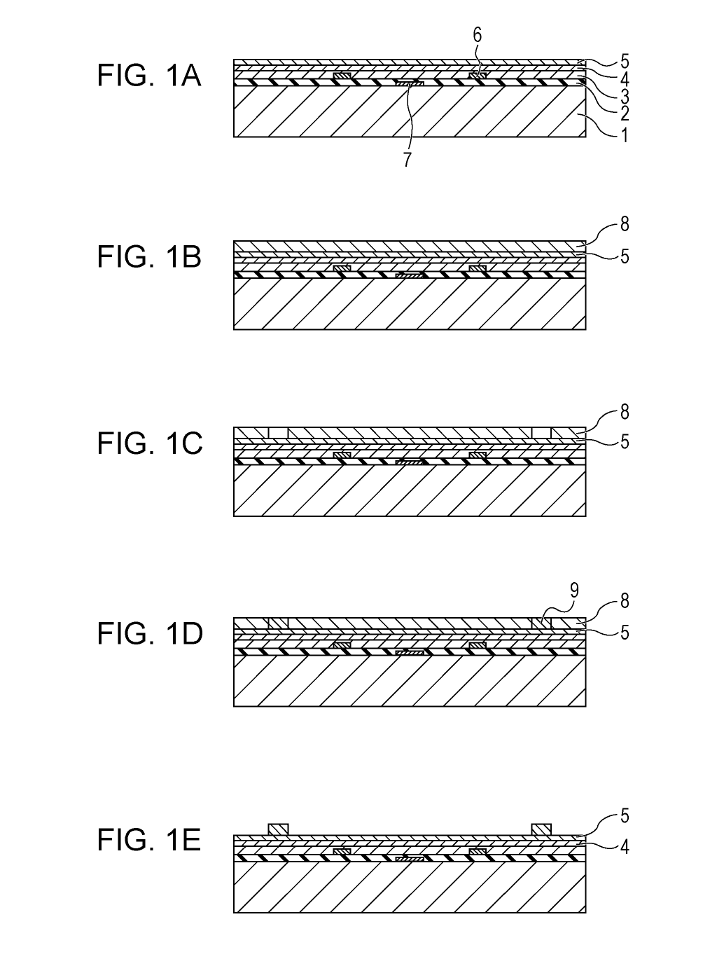

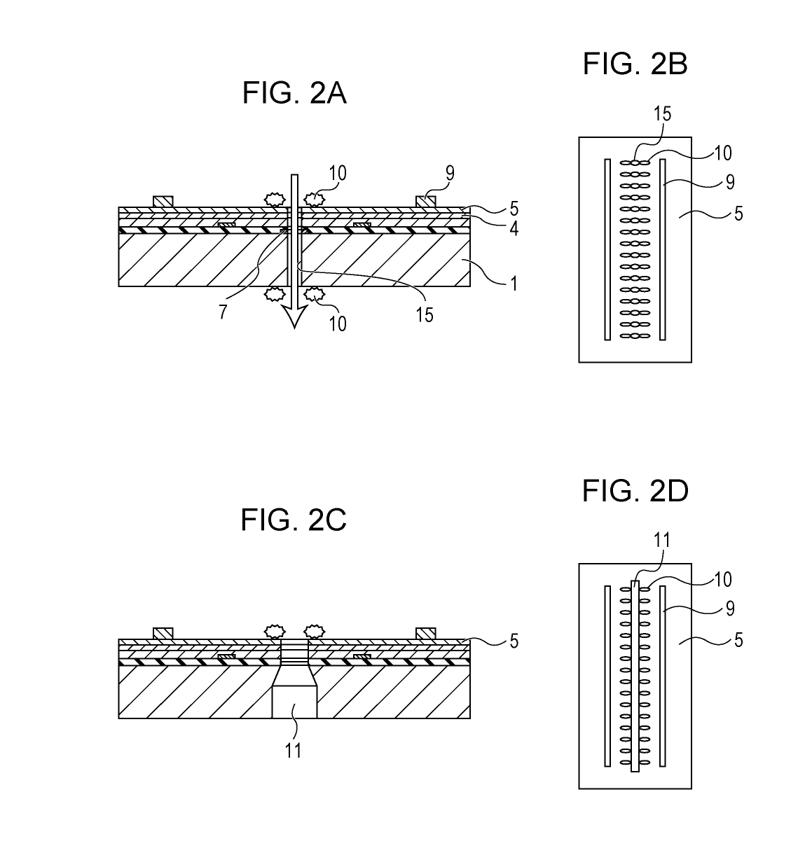

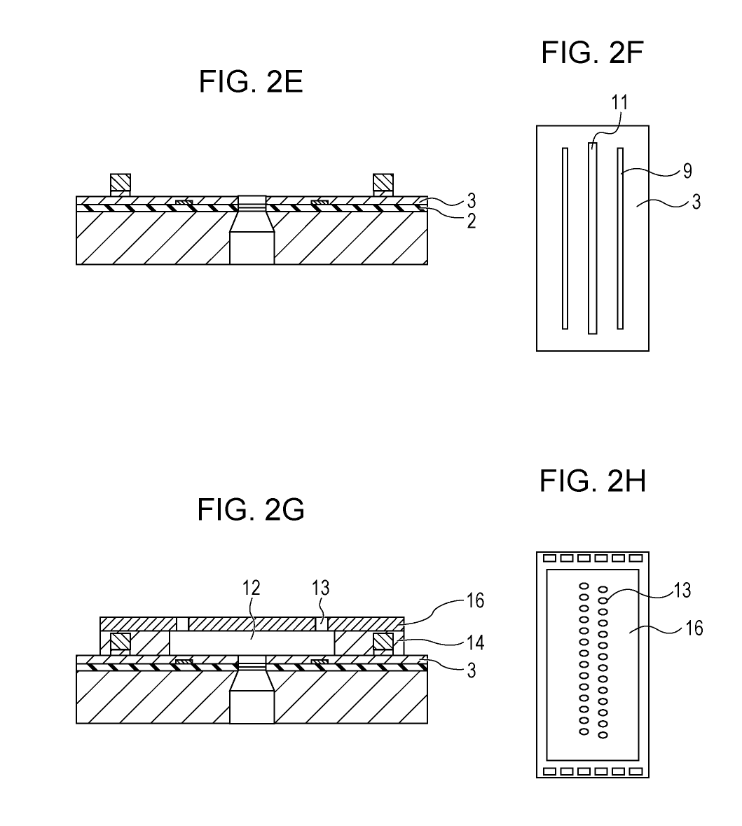

The method according to the first embodiment is described with reference to FIGS. 1A to 1E and 2A to 2H. FIGS. 1A to 1E, 2A, 2C, 2E, and 2G are sectional views taken along the line A-A of FIG. 5. FIGS. 2B, 2D, 2F, and 2H are top views corresponding to FIGS. 2A, 2C, 2E, and 2G, respectively.

With reference to FIG. 1A, the substrate 1 is overlaid with a sacrificial layer 7, an interlayer insulation layer 2, and the ink discharge energy-generating elements 6. The substrate 1 may be a silicon substrate. The ink discharge energy-generating elements 6 may be made of, for example, a heat-generating resistor such as TaSiN. The sacrificial layer 7 may contain, for example, aluminum, an aluminum compound, a compound of aluminum and silicon, aluminum-copper, or the like. These materials may be used alone or in combination. The interlayer insulation layer 2 may be made of SiO, SiN, or the like. In FIG. 1D and figures subsequent thereto, the wiring section 9 is shown and semiconductor elements formed for the purpose of driving the ink discharge energy-generating elements 6 are not shown. The ink discharge energy-generating elements 6, the sacrificial layer 7, wiring lines, and other elements are covered with a protective insulation layer 3. The protective insulation layer 3 may be made of SiO, SiN, or the like. A barrier layer 4 is formed on the protective insulation layer 3. The barrier layer 4 prevents a seed layer 5 below from being diffused in the protective insulation layer 3 and enhances the adhesion of the seed layer 5. The barrier layer 4 preferably contains at least one selected from the group consisting of Ti, W, compounds containing Ti and W, and TiN. The barrier layer 4 preferably has a thickness of 170 nm to 300 nm and more preferably 180 nm to 250 nm. The seed layer 5, which is used to form the wiring section 9 as described below, is formed on the barrier layer 4. The seed layer 5 functions as a protective film against debris caused by laser processing below. The seed layer 5 is preferably made of a metal insoluble in an etching solution used for anisotropic etching below because the seed layer 5 can be used as an etching protective layer. In particular, the seed layer 5 preferably contains at least one selected from the group consisting of Au, Ag, and Cu. The seed layer 5 preferably has a thickness of 30 nm to 80 nm and more preferably 40 nm to 60 nm.

As shown in FIG. 1B, a resist film 8 is formed on the seed layer 5. A chemical solution used to form the resist film 8 may be, for example, a commercially available product such as PMER P-LA300PM™ available from Tokyo Ohka Kogyo Co., Ltd. A method of applying the chemical solution is not particularly limited. The resist film 8 preferably has a thickness of 10 nm to 500 nm and more preferably 45 nm to 55 nm. The resist film 8 may be formed by attaching a resist sheet or the like instead of applying the chemical solution.

As shown in FIG. 1C, the resist film 8 is exposed to light and is then developed, whereby the resist film 8 is patterned so as to have an opening corresponding to the wiring section 9, which is used to drive the ink discharge energy-generating elements 6. A method of expose the resist film 8 is not particularly limited and is capable of precisely patterning the resist film 8. A chemical solution used to develop the resist film 8 may be, for example, a commercially available product such as NMD-3™ available from Tokyo Ohka Kogyo Co., Ltd.

As shown in FIG. 1D, the wiring section 9 is formed in the opening of the patterned resist film 8 by plating using the patterned resist film 8 as a plating mask. A material used to form the wiring section 9 may be Au, Ag, or Cu and is preferably the same as that used to form the seed layer 5. These materials may be used alone or in combination. A plating process used is not particularly limited and is capable of forming the wiring section 9 by sufficiently filling the opening of the patterned resist film 8 with a material for forming the wiring section 9. The wiring section 9 may be formed by a process, other than plating, capable of forming the wiring section 9 by sufficiently filling the opening of the patterned resist film 8 with the material for forming the wiring section 9.

As shown in FIG. 1E, the patterned resist film 8, which is used as a plating mask, is removed with a stripping solution. The stripping solution depends on a material used to form the resist film 8 and may be, for example, a commercially available product such as Microposit Remover™ 1112A available from Rohm and Haas Electronic Materials K.K.

As shown in FIGS. 2A and 2B, a portion ranging from a surface of the substrate 1 that has the wiring section 9 to the sacrificial layer 7 is laser-processed, whereby a laser perforation 15 is formed. The laser processing depth is not particularly limited if the seed layer 5, the barrier layer 4, the protective insulation layer 3, the interlayer insulation layer 2, and the substrate 1 can be simultaneously processed. The substrate 1 may be perforated or need not be perforated. The substrate 1 is preferably perforated. The diameter of a laser spot may be within the framework of the sacrificial layer 7 and is preferably 10 μm to 200 μm and more preferably 20 μm to 30 μm. A laser processing pattern is within the framework of the sacrificial layer 7 and may be a linear pattern formed by continuous processing or a dotted pattern. The laser processing pattern is not particularly limited and may be one useful in forming the ink supply port 11 by anisotropic etching. The type of a laser used is not particularly limited and may be one capable of processing the seed layer 5, the barrier layer 4, the protective insulation layer 3, the interlayer insulation layer 2, and the substrate 1. The laser used may be, for example, a YAG laser or the like. Molten debris 10 caused by laser processing adheres to surroundings (both surfaces of the substrate 1) of the laser perforation 15. In the present invention, a step of forming a protective film for protecting a surface of the substrate 1 from the debris 10 caused by laser processing can be excluded prior to the step of performing laser processing.

As shown in FIGS. 2C and 2D, the ink supply port 11 is formed in the substrate 1 by anisotropic etching. An etching solution used may be a solution containing, for example, tetramethylammonium hydroxide (TMAH) and water and arbitrarily containing silicon. The concentration of TMAH is preferably 8% to 25% by mass with respect to water. The content of silicon in the etching solution is preferably 0% to 8% by mass. The temperature of the etching solution is preferably maintained at 80° C. to 90° C. during anisotropic etching. Another solution other than the etching solution may be used for anisotropic etching if this solution does not dissolve the seed layer 5 or the wiring section 9. After a protective film against the etching solution is formed over the seed layer 5 and the wiring section 9, anisotropic etching may be performed. For example, OBC™ available from Tokyo Ohka Kogyo Co., Ltd. can be used to form the protective film against the etching solution. However, from the viewpoint of simplifying steps, it is preferred that the protective film against the etching solution is not formed and the seed layer 5 is used as a protective film against the etching solution. The front surface of the substrate 1 is covered with the seed layer 5 and the wiring section 9, which are insoluble in the etching solution, or the resist film and therefore is not etched. In contrast, the back surface of the substrate 1 is not covered with any film resistant to the etching solution and therefore etching proceeds from the back surface of the substrate 1 toward the front surface of the substrate 1. The debris 10, caused by laser processing, adhering to the back surface of the substrate 1 is lifted off simultaneously with etching and therefore does not remain on the etched back surface of the substrate 1. In the case of forming the protective film against the etching solution, the protective film against the etching solution is removed after etching.

As shown in FIGS. 2E and 2F, the barrier layer 4 and the seed layer 5, which are used to form the wiring section 9, are removed. In this step, the debris 10, caused by laser processing, adhering to surroundings of the laser perforation 15 is also lifted off. A chemical solution used to remove the seed layer 5 depends on the type of the seed layer 5 and may be a solution containing iodine, potassium iodide, or the like. A chemical solution used to remove the barrier layer 4 depends on the type of the barrier layer 4 and may be a solution containing hydrogen peroxide or the like.

As shown in FIGS. 2G and 2H, the passage-forming member 14 is formed on the protective insulation layer 3 in order to form the passage 12. A method of forming the passage-forming member 14 is not particularly limited. The passage-forming member 14 can be formed by attaching, for example, a photosensitive dry film to the protective insulation layer 3. A region of the passage-forming member 14 that is used to form the wall of the passage 12 is exposed to light. Thereafter, the ink discharge port-forming member 16 is formed on the passage-forming member 14 in order to form the ink discharge ports 13. A method of forming the ink discharge port-forming member 16 is not particularly limited. The ink discharge port-forming member 16 can be formed by, for example, attaching a photosensitive dry film or applying a photosensitive resin to the passage-forming member 14. A surface of the ink discharge port-forming member 16 may be coated with a water-repellent material. A region of the ink discharge port-forming member 16 is exposed to light, the region being other than portions corresponding to the ink discharge ports 13. Unexposed portions of the passage-forming member 14 and the ink discharge port-forming member 16 are developed, whereby the passage 12 and the ink discharge ports 13 are formed. Through the above steps, the inkjet head is completed as shown in FIG. 5.

As described above, in the method according to this embodiment, the seed layer 5, which is used to form the wiring section 9, can be directly used as a protective film against the debris 10 caused by laser processing. Therefore, the following steps can be omitted: a step of forming a protective film for protecting a surface of the substrate 1 from the debris 10 caused by laser processing and a step of removing the protective film. When the seed layer 5 is made of the metal insoluble in the etching solution used for anisotropic etching, the seed layer 5 can be also used as a protective film against anisotropic etching.

### Second Embodiment

A method of processing an inkjet head substrate according to a second embodiment of the present invention includes the following steps in this order:

(a) a step of forming a barrier layer on a substrate and forming a seed layer on the barrier layer,
(b) a step of laser-processing a surface of the substrate,
(c) a step of forming a resist film on the seed layer and patterning the resist film such that the resist film has an opening corresponding to a wiring section configured to drive ink discharge energy-generating elements,
(d) a step of forming the wiring section in the opening of the patterned resist film,
(e) a step of removing the resist film,
(f) a step of forming an ink supply port by anisotropically etching the substrate, and
(g) a step of removing the barrier layer and the seed layer.

This embodiment is different from the first embodiment in that a step of performing laser processing is directly subsequent to a step of forming a barrier layer 4 and a seed layer 5.

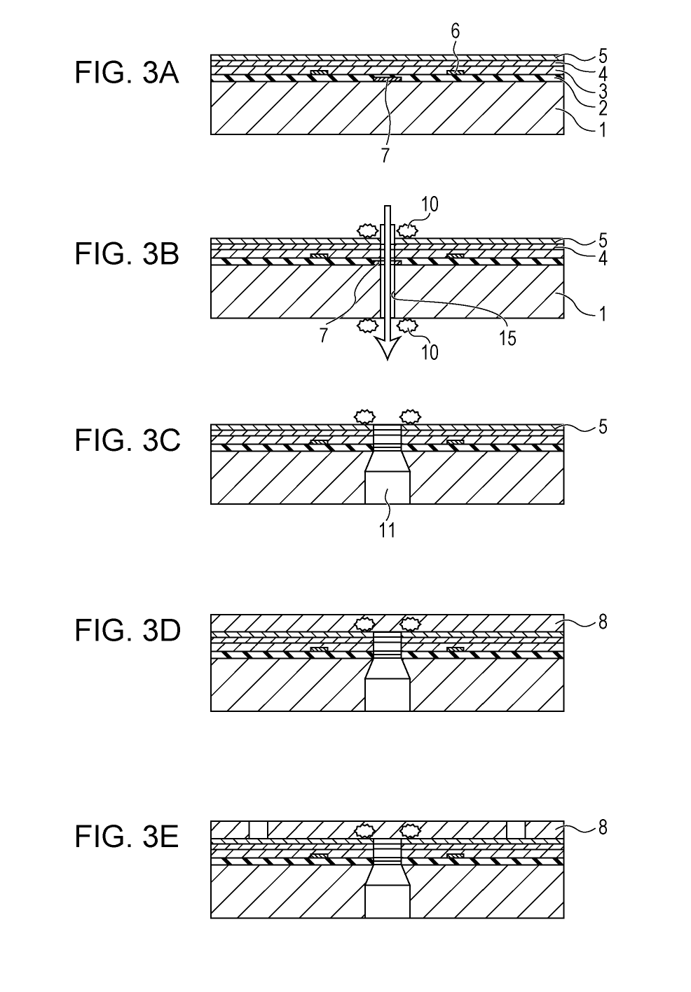

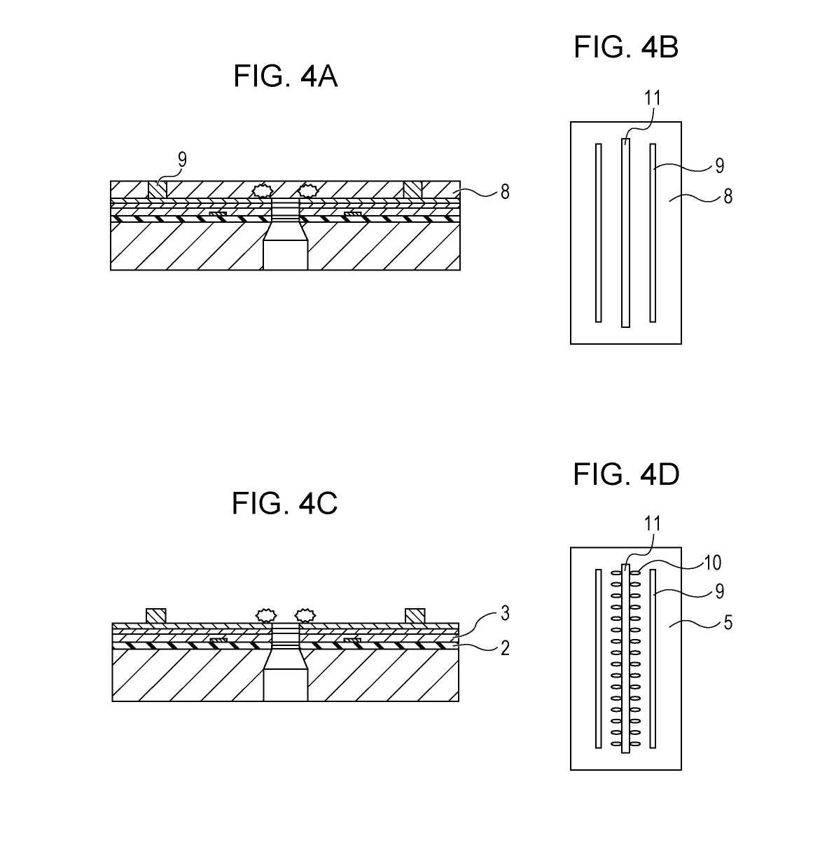

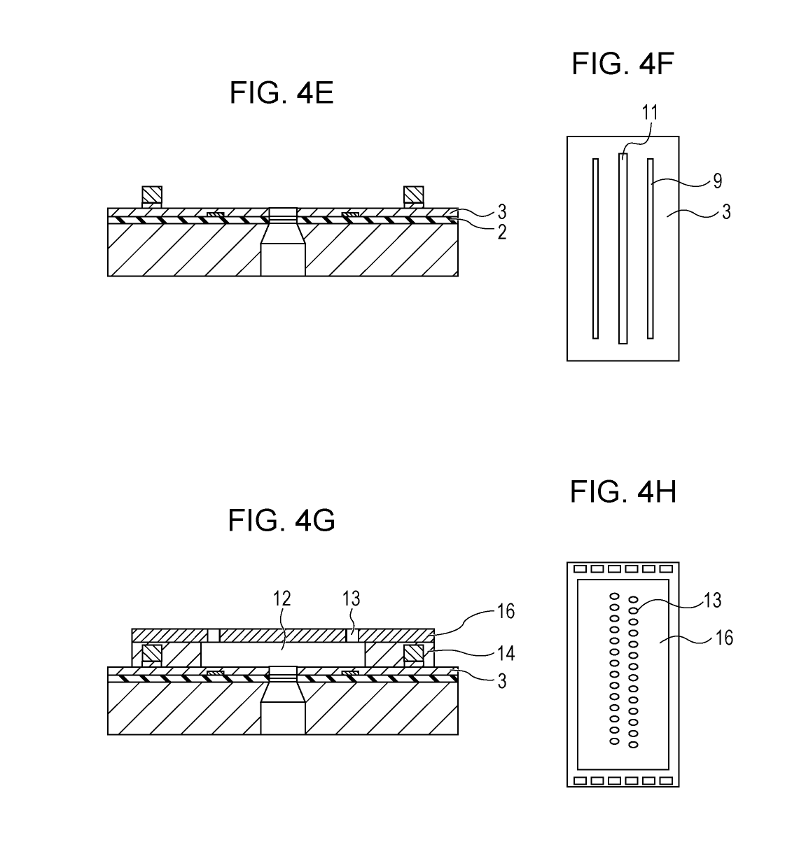

The method according to this embodiment is described with reference to FIGS. 3A to 3E and 4A to 4H. FIGS. 3A to 3E, 4A, 4C, 4E, and 4G are sectional views taken along the line A-A of FIG. 5. FIGS. 4B, 4D, 4F, and 4H are top views corresponding to FIGS. 4A, 4C, 4E, and 4G, respectively.

As shown in FIG. 3A, a protective insulation layer 3, the barrier layer 4, and the seed layer 5 are formed on a substrate 1 in substantially the same manner as that described in the first embodiment.

As shown in FIG. 3B, a portion ranging from a surface of the substrate 1 that has the seed layer 5 to a sacrificial layer 7 is laser-processed. The laser processing depth, the diameter of a laser spot, a laser processing pattern, and the type of a laser used may be substantially the same as those described in the first embodiment.

As shown in FIG. 3C, an ink supply port 11 is formed in the substrate 1 by anisotropic etching in substantially the same manner as that described in the first embodiment.

As shown in FIG. 3D, a resist film 8 is formed on the seed layer 5 having a laser perforation 15 in substantially the same manner as that described in the first embodiment.

As shown in FIG. 3E, the resist film 8 is exposed to light and is then developed in substantially the same manner as that described in the first embodiment, whereby the resist film 8 is patterned so as to have an opening corresponding to a wiring section 9 for driving ink discharge energy-generating elements 6 below.

As shown in FIGS. 4A and 4B, the wiring section 9 is formed in the opening of the patterned resist film 8 by plating using the patterned resist film 8 as a plating mask in substantially the same manner as that described in the first embodiment.

As shown in FIGS. 4C and 4D, the patterned resist film 8, which is used as a plating mask, is removed with a stripping solution in substantially the same manner as that described in the first embodiment.

As shown in FIGS. 4E and 4F, the barrier layer 4 and the seed layer 5, which are used to form the wiring section 9, are removed in substantially the same manner as that described in the first embodiment.

As shown in FIGS. 4G and 4H, a passage-forming member 14, an ink discharge port-forming member 16, a passage 12, and ink discharge ports 13 are formed in substantially the same manner as that described in the first embodiment. Through the above steps, an inkjet head is completed as shown in FIG. 5.

In this embodiment, substantially the same effects as those described in the first embodiment can be obtained.

### EXAMPLES

Examples of the present invention are described below. These examples are not intended to limit the present invention in any way.

### Example 1

A method of processing an inkjet head substrate according to this example is described with reference to FIGS. 1A to 1E and 2A to 2H.

As shown in FIG. 1A, a substrate 1 was overlaid with a sacrificial layer 7, an interlayer insulation layer 2, and a plurality of ink discharge energy-generating elements 6. The substrate 1 was a silicon substrate. The ink discharge energy-generating elements 6 were made of a heat-generating resistor containing TaSiN. The sacrificial layer 7 was made of aluminum. As for wiring lines connected to the ink discharge energy-generating elements 6, a wiring section 9 only is shown in FIG. 1D and figures subsequent thereto. Semiconductor elements for driving the ink discharge energy-generating elements 6 are not shown. The ink discharge energy-generating elements 6, the sacrificial layer 7, wiring lines, and other elements were covered with a protective insulation layer 3. A barrier layer 4 was formed on the protective insulation layer 3. The barrier layer 4 was intended to prevent a seed layer 5 from being diffused in the protective insulation layer 3. A material used to form the barrier layer 4 was TiW. The barrier layer 4 had a thickness of 200 nm. The seed layer 5, which was used to form the wiring section 9 as described below, was formed on the barrier layer 4. A material used to form the seed layer 5 was Au. The seed layer 5 had a thickness of 50 nm.

As shown in FIG. 1B, a resist was applied to the seed layer 5, whereby a resist film 8 was formed on the seed layer 5. The resist used was a chemical solution mainly containing PMER P-LA300PM™ available from Tokyo Ohka Kogyo Co., Ltd.

As shown in FIG. 1C, the resist film 8 was exposed to light and was then developed, whereby a plating mas was formed. NMD-3™ available from Tokyo Ohka Kogyo Co., Ltd. was used to develop the resist film 8.

As shown in FIG. 1D, the wiring section 9 was formed by plating using the plating mask, which was formed from the resist film 8. A material used to form the wiring section 9, as well as the material used to form the seed layer 5, was Au.

As shown in FIG. 1E, the plating mask, which was formed from the patterned resist film 8, was removed with a stripping solution. The stripping solution used was Microposit Remover™ 1112A available from Rohm and Haas Electronic Materials K.K.

As shown in FIGS. 2A and 2B, a portion ranging from a surface of the substrate 1 that had the wiring section 9 to the sacrificial layer 7 was laser-processed. The processing depth was set such that the substrate 1 was perforated. This resulted in that a laser perforation 15 was formed. The diameter of a laser spot was adjusted to 30 μm. A laser processing pattern was formed such that dots were linearly arranged in the framework of the sacrificial layer 7. A laser used was a YAG laser.

As shown in FIGS. 2C and 2D, an ink supply port 11 was formed in the substrate 1 by anisotropic etching. An etching solution used was an aqueous solution containing 22% by mass of TMAH. The temperature of the etching solution was maintained at 83° C. during anisotropic etching.

As shown in FIGS. 2E and 2F, the seed layer 5 and the barrier layer 4, which were used to form the wiring section 9, were removed. A chemical solution mainly containing iodine and potassium iodide was used to remove the seed layer 5. Aqueous hydrogen peroxide was used to remove the barrier layer 4.

As shown in FIGS. 2G and 2H, in order to form a passage 12, a passage-forming member 14 was formed on the protective insulation layer 3 by attaching a photosensitive dry film to the protective insulation layer 3. A region of the passage-forming member 14 that corresponded to the wall of the passage 12 was exposed to light. Furthermore, in order to form ink discharge ports 13, an ink discharge port-forming member 16 was formed on the passage-forming member 14 by applying a photosensitive resin to the passage-forming member 14. A region of the ink discharge port-forming member 16 was exposed to light, the region being other than portions corresponding to the ink discharge ports 13. The passage-forming member 14 and the ink discharge port-forming member 16 were developed, whereby the passage 12 and the ink discharge ports 13 were formed. This resulted in the manufacture of an inkjet head.

### Example 2

A method of processing an inkjet head substrate according to this example is described with reference to FIGS. 3A to 3E and 4A to 4H. This example is different from Example 1 in that a step of forming a laser perforation 15 is directly subsequent to a step of forming a seed layer 5.

As shown in FIG. 3A, a protective insulation layer 3, a barrier layer 4, and the seed layer 5 were formed on a substrate 1 in substantially the same manner as that described in Example 1.

As shown in FIG. 3B, a portion ranging from a surface of the substrate 1 that had the seed layer 5 to a sacrificial layer 7 was laser-processed. The laser processing depth, the diameter of a laser spot, a laser processing pattern, and the type of a laser used were substantially the same as those described in Example 1.

As shown in FIG. 3C, an ink supply port 11 was formed in the substrate 1 by anisotropic etching. An etching solution used was an aqueous solution containing 22% by mass of TMAH. The temperature of the etching solution was maintained at 83° C. during anisotropic etching.

As shown in FIG. 3D, a resist film 8 was attached to the seed layer 5 having the laser perforation 15. The resist film 8 used was a dry film mainly containing PMER P-LA300PM™ available from Tokyo Ohka Kogyo Co., Ltd.

As shown in FIG. 3E, a plating mask was formed in such a manner that the resist film 8 was exposed to light and was then developed. NMD-3™ available from Tokyo Ohka Kogyo Co., Ltd. was used to develop the resist film 8.

As shown in FIGS. 4A and 4B, a wiring section 9 was formed by plating using the plating mask, which was formed from the resist film 8, in substantially the same manner as that described in Example 1.

As shown in FIGS. 4C and 4D, the plating mask, which was formed from the resist film 8, was removed with a stripping solution in substantially the same manner as that described in Example 1.

As shown in FIGS. 4E and 4F, the seed layer 5 and the barrier layer 4, which were used to form the wiring section 9, were removed in substantially the same manner as that described in Example 1.

As shown in FIGS. 4G and 4H, a passage-forming member 14, an ink discharge port-forming member 16, a passage 12, and ink discharge ports 13 were formed in substantially the same manner as that described in Example 1. This resulted in the manufacture of an inkjet head.

According to the present invention, the following steps can be omitted: a step of forming a protective film for protecting a surface of a substrate from debris caused by laser processing and a step of removing the protective film.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-119401 filed May 25, 2012, which is hereby incorporated by reference herein in its entirety.

What is claimed is:

1. A method of processing an inkjet head substrate, comprising, in series:
(a) a step of forming a barrier layer on a substrate and forming a seed layer on the barrier layer;
(b) a step of forming a resist film on the seed layer and patterning the resist film such that the resist film has an opening corresponding to a wiring section configured to drive ink discharge energy-generating elements;
(c) a step of forming the wiring section in the opening of the patterned resist film;
(d) a step of removing the resist film;
(e) a step of laser-processing a surface of the substrate;
(f) a step of forming an ink supply port by anisotropically etching the substrate; and
(g) a step of removing the barrier layer and the seed layer.

2. A method of processing an inkjet head substrate, comprising, in series:
(a) a step of forming a barrier layer on a substrate and forming a seed layer on the barrier layer;
(b) a step of laser-processing a surface of the substrate;
(c) a step of forming a resist film on the seed layer and patterning the resist film such that the resist film has an opening corresponding to a wiring section configured to drive ink discharge energy-generating elements;
(d) a step of forming the wiring section in the opening of the patterned resist film;
(e) a step of removing the resist film;
(f) a step of forming an ink supply port by anisotropically etching the substrate; and
(g) a step of removing the barrier layer and the seed layer.

3. The method according to claim 1, wherein any step of forming a protective film used to protect a surface of the substrate from debris caused by laser processing is not performed prior to the step of laser-processing the substrate surface.

4. The method according to claim 1, wherein the seed layer contains at least one selected from the group consisting of Au, Ag, and Cu.

5. The method according to claim 1, wherein the seed layer has a thickness of 30 nm to 80 nm.

6. The method according to claim 1, wherein the barrier layer contains at least one selected from the group consisting of Ti, W, compounds containing Ti and W, and TiN.

7. The method according to claim 1, wherein the barrier layer has a thickness of 170 nm to 300 nm.

8. The method according to claim 1, wherein the laser processing is a process of perforating the substrate.

9. The method according to claim 2, wherein any step of forming a protective film used to protect a surface of the substrate from debris caused by laser processing is not performed prior to the step of laser-processing the substrate surface.

10. The method according to claim 2, wherein the seed layer contains at least one selected from the group consisting of Au, Ag, and Cu.

11. The method according to claim 2, wherein the seed layer has a thickness of 30 nm to 80 nm.

12. The method according to claim 2, wherein the barrier layer contains at least one selected from the group consisting of Ti, W, compounds containing Ti and W, and TiN.

13. The method according to claim 2, wherein the barrier layer has a thickness of 170 nm to 300 nm.

14. The method according to claim 2, wherein the laser processing is a process of perforating the substrate.
